(19) United States
(12) Patent Application Publication
(10) Pub. No.: US 2015/0156460 A1
(43) Pub. Date: Jun. 4, 2015

(54) SYSTEM AND METHOD OF FILLING IN GAPS IN IMAGE DATA

(71) Applicant: Andrew Szybalski, San Francisco, CA (US)

(72) Inventor: Andrew Szybalski, San Francisco, CA (US)

(73) Assignee: GOOGLE INC., Mountain View, CA (US)

(21) Appl. No.: 12/574,190

(22) Filed: Oct. 6, 2009

(51) Int. Cl. G06Q 30/00; H04N 7/18; G06F 15/16; G06K 9/00; H04N 5/445; H04W 4/02; G06T 7/00; G01C 21/00

(52) U.S. Cl. CPC H04N 7/18; H04N 5/445; H04W 4/02; G06T 7/004; G06K 9/00476

(57) ABSTRACT

A system and method of determining locations which require additional images is provided. The system may make this determination based on a number of factors. The system and method also involve sending users notifications requesting images. A server may receive location information from a client device and determine an approximate location of the device. If the client device is currently located proximate to a location which requires additional images, the server may send the client device a notification. In response to the notification the user may take an image of the location, upload the image, and receive incentives to maintain user interest.

### BACKGROUND OF THE INVENTION

Systems heretofore utilize incentives to increase user participation. For example, some services grant users titles or badges for completing certain tasks before other users. Other systems, for example networking websites which maintain user profiles, may indicate a completion percentage of a user's profile. In another example, some videogames award arbitrary points to uses which complete tasks and succeed at the game. These examples motivate users to add information to their profiles and invite others to participate.

Map services also provide users with incentives for providing information. For example, the Google Maps service identifies which users have contributed information to the website. Other systems provide tips about things to do in the area based on GPS location and reward users with reputation points or badges for completing various types of activities.

Some map services such as Google's Street View provide users with street level and other images of locations. These types of map services often desire a great deal of images and image information in order to provide comprehensive and up to date coverage.

### BRIEF SUMMARY OF THE INVENTION

One aspect includes a method of providing notifications to a user. The method involves receiving a location of a user device; determining whether the client device's location is proximate to a first geographic location, where the first geographic location was determined by a processor by analyzing the images of an image source, where the images of the image source are associated with data identifying geographic locations; and notifying a user, via the client device, when the client device's location is proximate to the first geographic location, to capture an image of the first location.

Another aspect includes a method of providing images on a computer network. The method involves receiving, at a first node on the network associated with a user and a user account, a request indicating that an image is needed at a location, wherein the first node of the network is at a geographic location which is proximate to the location; taking an image of the location; and transmitting, to a second node on the network, the image of the location.

Still another aspect provides a computer-usable medium including a program executable by a processor. The program includes computer code that maintains images of a plurality of locations; computer code that determines which of the plurality of locations require images; computer code that receives location information from a user device; computer code that determines a geographic location of the user device; computer code that determines if the geographic location of the user device is proximate to a location which requires an image; and computer code that transmits a notification requesting an image to the user device.

In yet another aspect, a system is provided. The system includes a first computer at a first node of a network, the first computer having access to instructions operable by the first computer, a set of locations, a set of images each image associated with one of the set of locations; and a client device at a second node of the network different from the first node, the client device comprising a user input device, an electronic display, a processor and instructions operable by the processor. The instructions of the first computer include receiving location data from the user device; determining a location of the set of locations require additional images; determining if the location data indicates a location which is proximate to the location of the set of locations which require an image; generating a notification based on the location which require an image; and transmitting the notification to the client device over the network. The instructions of the second computer include transmitting location data to the first computer and displaying, on the electronic display, the notification transmitted by the first computer.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3 is a diagram in accordance with one aspect of the invention.

FIG. 4 is a flowchart in accordance with an aspect of the invention.

FIG. 5 is a client device and screen image in accordance with an aspect of the invention.

FIG. 6 is a client device and screen image in accordance with an aspect of the invention.

FIG. 7 is a client device and screen image in accordance with an aspect of the invention.

FIG. 8 is a client device and a screen image in accordance with an aspect of the invention.

FIG. 9 is a client device and a screen image in accordance with an aspect of the invention.

FIG. 10 is a screen shot in accordance with an aspect of the invention.

FIG. 11 is a screen shot in accordance with an aspect of the invention.

FIG. 12 is a screen shot in accordance with an aspect of the invention.

FIG. 13 is a flow diagram in accordance with an aspect of the invention.

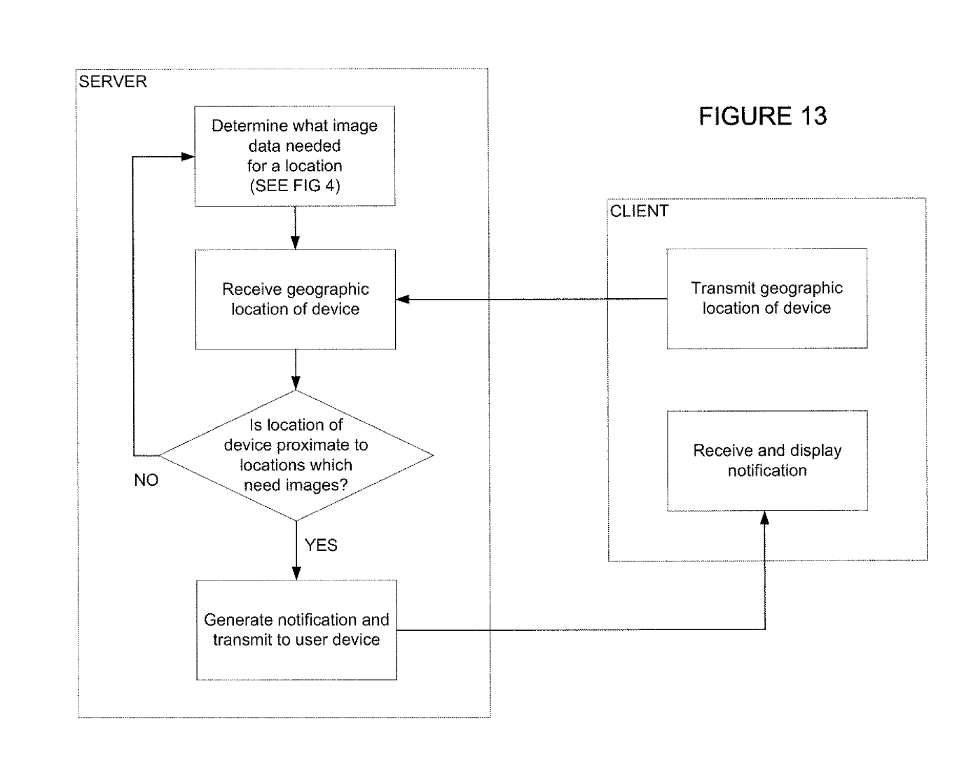

### DETAILED DESCRIPTION

In one aspect, the system and method involve determining locations which require additional images. A server may make this determination based on a number of factors. The server may receive location information from a client device and determine a location of the device. If the client device is currently located proximate to a location which require an additional image, the server may send the client device a notification. Notifications may be automatic and may indicate one or more locations where an image is required. In response the user may take an image of the location, upload the image, and receive incentives to maintain the user's interest.

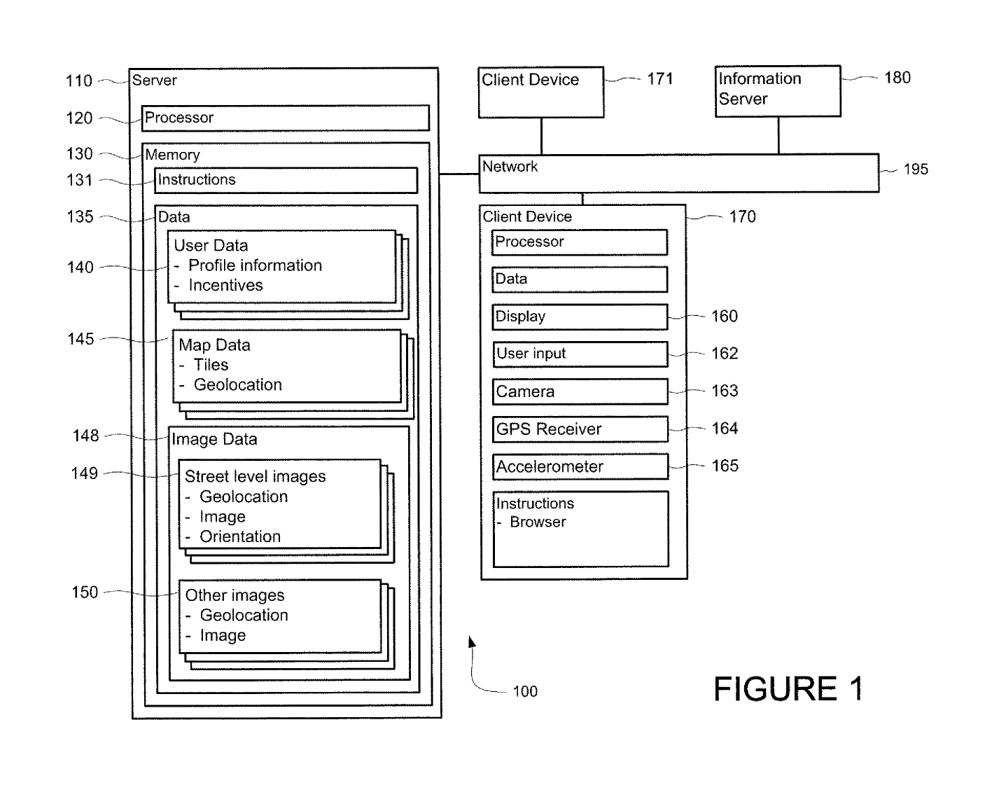

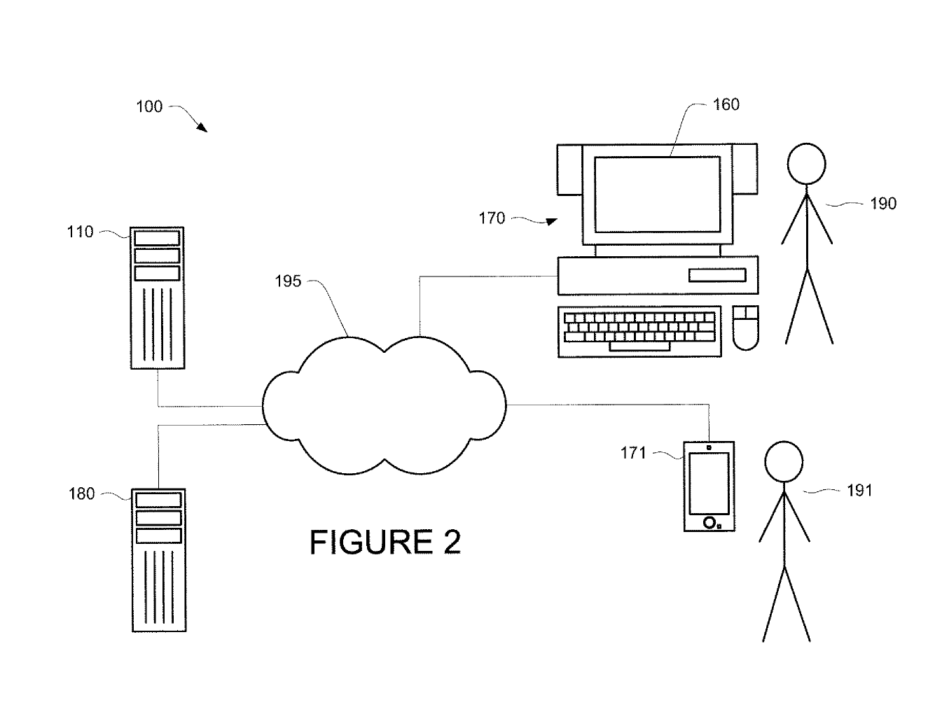

As shown in FIGS. 1-2, a system 100 in accordance with one aspect of the invention includes a computer 110 containing a processor 120, memory 130 and other components typically present in general purpose computers.

Memory 130 stores information accessible by processor 120, including instructions 131 that may be executed by the processor 120. It also includes data 140 that may be retrieved, manipulated or stored by the processor. The memory may be of any type capable of storing information accessible by the processor, such as a hard-drive, memory card, ROM, RAM, DVD, CD-ROM, write-capable, and read-only memories. The processor 120 may be any well-known processor, such as processors from Intel Corporation or AMD. Alternatively, the processor may be a dedicated controller such as an ASIC.

The instructions 131 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 135 may be retrieved, stored or modified by processor 120 in accordance with the instructions 131. For instance, although the system and method is not limited by any particular data structure, the data may be stored in computer registers, in a relational database as a table having a plurality of different fields and records, XML documents, or flat files. The data may also be formatted in any computer-readable format such as, but not limited to, binary values, ASCII or Unicode. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one aspect, computer 110 is a server communicating with one or more client computers 170-71 as well as one or more information servers 180 (only one additional server being depicted in FIGS. 1-2 for clarity). For example, computers 110, 180 may be web servers. Computers 170-171, 180 may be configured similarly to the server 110, with a processor, memory and instructions.

Each client computer 170-71 may be a personal computer, intended for use by a person 190-191, having all the internal components normally found in a personal computer such as a central processing unit (CPU), display device 160 (for example, a monitor having a screen, a projector, a touch-screen, a small LCD screen, a television, or another device such as an electrical device that is operable to display information processed by the processor), CD-ROM, hard-drive, user input 162 (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, and set-top boxes for televisions.

Although the computers 170-71, 180 may comprise a full-sized personal computer, the system and method may also be used in connection with mobile devices capable of wirelessly exchanging data with a server over a network such as the Internet. For example, client computer 170 may be a wireless-enabled PDA such as a Blackberry phone or an Internet-capable cellular phone. In either regard, the user may input information using a small keyboard (in the case of a Blackberry phone), a keypad (in the case of a typical cell phone), a touch screen (in the case of a PDA), a camera 163, or any other means of user input.

The client devices may also include a position component 164, such as circuits, to determine the geographic location and orientation of the device. For example, client device 170 may include a GPS receiver to determine the device's latitude, longitude and altitude position. The component may also comprise software for determining the position of the device based on other signals received at the client device 170, such as signals received at a cell phone's antenna from one or more cell phone towers if the client device is a cell phone. It may also include an accelerometer 165 or gyroscope to determine the direction in which the device is oriented. By way of example only, the device may determine its pitch, yaw or roll (or changes thereto) relative to the direction of gravity or a plane perpendicular thereto.

Location and orientation information may be transmitted to the server 110 periodically by a program of the client device or received by server 110 during connection with the client device in conformance with communication protocols. For example, the device may use a browser such as Google Chrome or the browser of the Android operating system, each of which may be configured with user permission to send GPS information to trusted network sites (such as www.google.com). In that regard, it will be understood that a client device's provision of location and orientation data as set forth herein may be provided automatically to the user, to the server, or both.

Server 110 may use the location and orientation information to determine a location of the device. Because the accuracy of GPS determinations may depend on the quality of the device and external factors such as environment, the device may further transmit data indicative of accuracy. For example, the client device 170 may inform the server 110 that the transmitted latitude/longitude position is accurate within 100 meters, i.e., the device may be at any location within 100 meters of the transmitted position. The server may also assume a level of accuracy in the absence of such information.

The server 110, client computers 170-71, and information server 180 are capable of direct and indirect communication, such as over a network 195. Although only a few computers are depicted in FIGS. 1-2, it should be appreciated that a typical system can include a large number of connected computers, with each different computer being at a different node of the network 195. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

Although certain advantages are obtained when information is transmitted or received as noted above, other aspects of the system and method are not limited to any particular manner of transmission of information. For example, in some aspects, information may be sent via a medium such as a disk, tape or CD-ROM. In other aspects, the information may be transmitted in a non-electronic format and manually entered into the system. Yet further, although some functions are indicated as taking place on a server and others on a client, various aspects of the system and method may be implemented by a single computer having a single processor.

Data 150 may be associated with user data 141. User data 141 identifies users of the systems, i.e., any entity that interacts with the system and method such as people who upload images to server 110. As described in more detail below, user data 141 may also store information regarding incentives earned and profile information for each user.

Map data 145 of server 110 may store map-related information, at least a portion of which may be transmitted to a client device. For example, map database 145 may store map tiles 147, where each tile is a map image of a particular geographic area. Depending on the resolution (e.g., whether the map is zoomed in or out), one tile may cover an entire region, such as a state, in relatively little detail. Another tile may cover just a few streets in high detail. The map information is not limited to any particular format. For example, the images may comprise street maps, satellite images, or a combination of these, and may be stored as vectors (particularly with respect to street maps) or bitmaps (particularly with respect to satellite images). The various map tiles 147 are each associated with geographical locations, such that the server 110 is capable of selecting, retrieving and transmitting one or more tiles in response to receipt of a geographical location.

As noted below, the locations may be expressed in various ways including but not limited to latitude/longitude positions, street addresses, points on a map (such as when a user clicks on a map), building names, other data capable of identifying one or more geographic locations, and ranges of the foregoing.

Data 135 may also include image data 148 associated with geographic locations. For example, street level images 149 may be associated with a particular geographic location, such as latitude and longitude. Other images 150, for example, areal views, views of the inside of a building, and other non-street level views may also be associated with a geographic location.

In addition to being associated with geographic locations, street level images 149 are typically associated with information indicating the orientation of the image. For example, if the street level image comprises a typical photograph, the orientation may indicate the camera angle such as data representing an angle that is 30° east of true north and rises 2° from ground level. If the street level images are panoramic images, such as 360° panoramas centered at the geographic location associated with the image, the orientation may indicate the portion of the image corresponding with looking due north from the camera position at an angle directly parallel to the ground.

The instructions of the client device may also include routines, such as a notification/upload program, for notifying the user of images requested by the server, uploading images of desired locations to the server, and other features as explained more detail below.

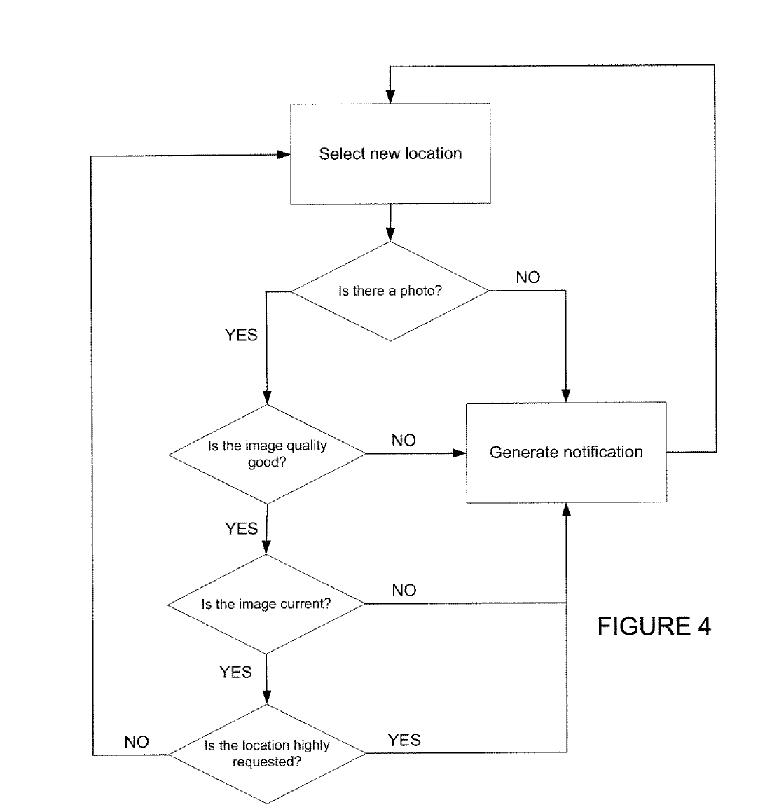

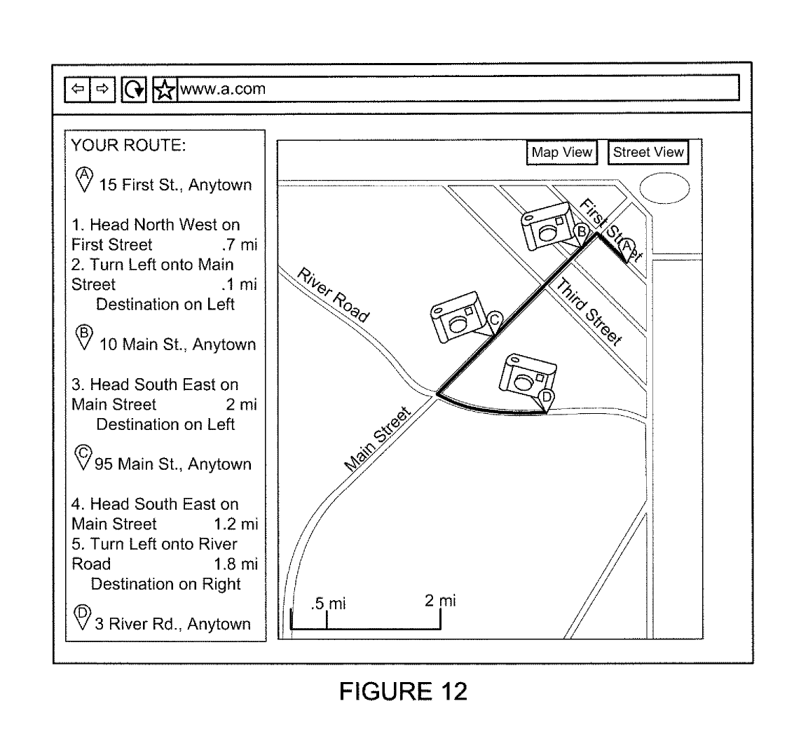

In addition to the operations illustrated in FIGS. 4 and 12, various operations in accordance with a variety of aspects of the invention will now be described. It should be understood that the following operations do not have to be performed in the precise order described below. Rather, various steps can be handled in reverse order or simultaneously.

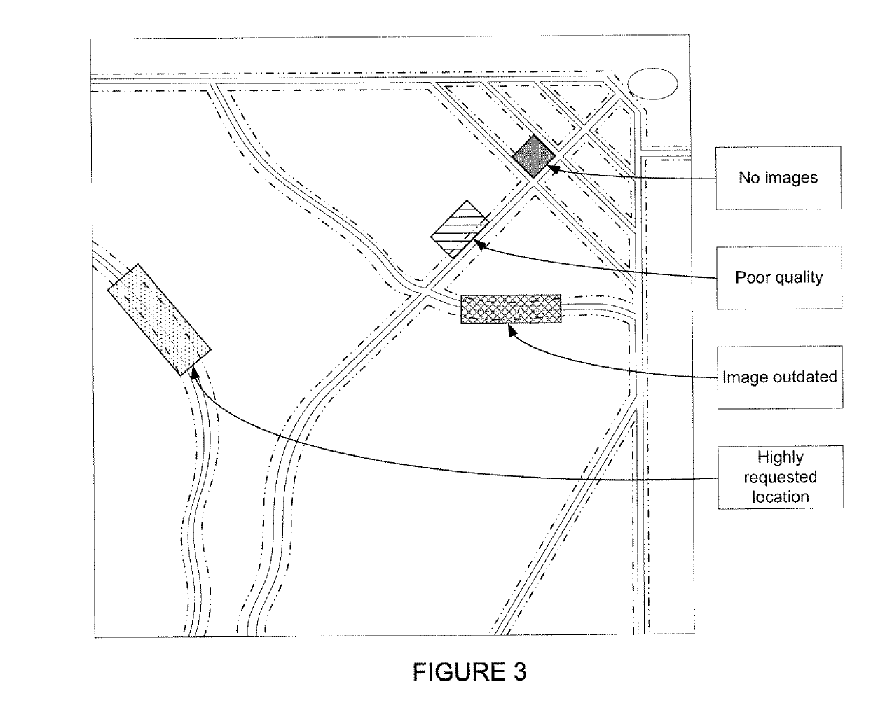

Server 110 may determine that images of specific locations are insufficient. As shown in FIG. 3, server 110 may store information regarding the status of images at various locations. For example, the server may determine that some locations, indicated in FIG. 3 by dotted lines, may be associated with sufficient images. Server 110 may determine that images in some areas are missing, completely lacking, defective, or out of date. Server 110 may also determine that images are insufficient because of a large number of user requests for information regarding a particular location. For ease of reading, the term “desired locations” and variants thereof refers to geographic locations that have been determined to merit newly-captured images.

Some locations may require additional images because of gaps in image data. For example, locations which have few or no images may require additional images. Such locations may be associated with a “percentage complete.” In another example, server 110 may determine that there are no images of a certain location. Such locations may be considered “uncharted territory” and defined as a number of miles from the nearest geographic location associated with an image.

Other locations may require additional images because although the server has access to an image, the image is defective. For example, the image may be of poor quality, too light, too dark, blurry, or the like. An image file may also be corrupted, scuth that the server 110 is unable to access or otherwise use the image.

Server 110 may determine that one or more images are required because the status or subject of a location has changed and the current image is out of date. This may be determined in various ways. For example, server 110 may connect to one or more information servers and retrieve information regarding the status of a particular location. Information server 180 may include information such as business listings, telephone directories, user contributions, or information about events at a particular location. Such changes in status may include a business closing, changing its name, a new building being constructed, or the like. Such changes may be expected to have an effect on the objects at the location, such as the signs on a building. In one example, server 110 may collect information from one or more data sources regarding the status of an area. Server 110 may use this information to determine that whether area as changed since the existing imagery was collected.

Server 110 may determine that additional images of a location are needed because of the volume of user requests regarding the location. For example, if a large number of users are requesting information regarding an address or other location, server 110 may determine that additional images are needed to satisfy the demand for information regarding the location.

The system may evaluate each of the above factors for a variety of different locations and determine whether additional images should be requested.

The system may provide a notification to users when the client device is proximate to a desired location. For instance, the client device's current location as determined by geographic position component 164 may be compared with a set of locations provided by the server 110. The comparison may occur at the client device 170 by downloading a set of desired locations from the server 110, by periodically uploading (with the user's permission) the location of the client device to the server 110, by via other systems and methods. The comparison may also occur at the specific request of the user, when the user selects a program, or automatically without user input. For ease of illustration and not by way of limitation, many of the remaining examples assume that a notification program on the client device 170 remains in periodic communication with server so as to determine whether the device is near a desired location.

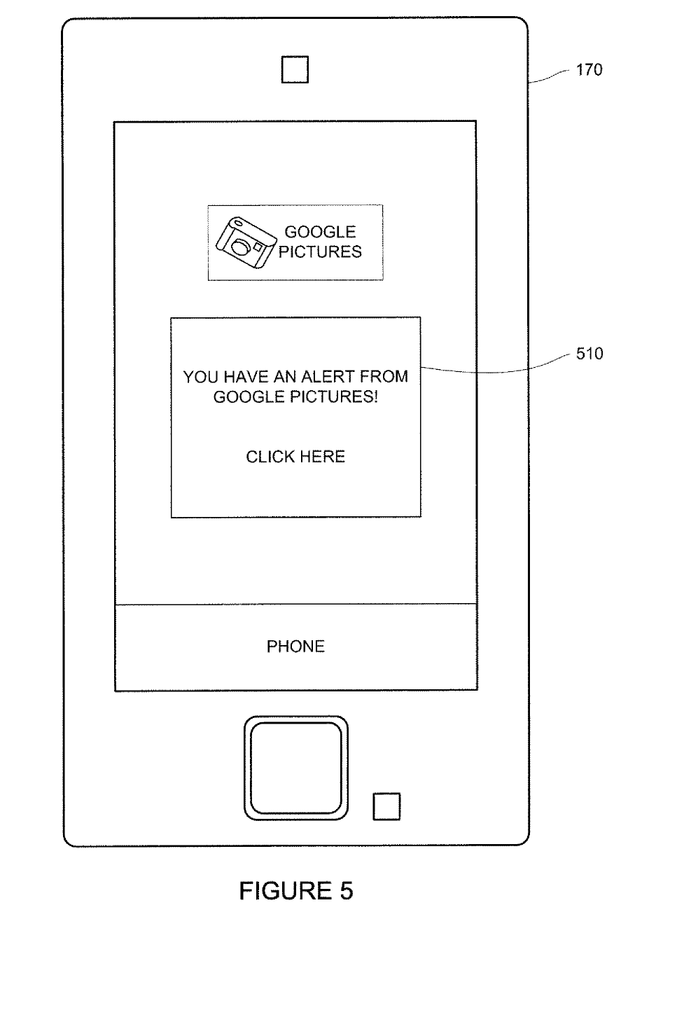

In one aspect, the notification is visual and occurs on the electronic display of the client device. As shown in FIG. 5, the client device 170 may display a notification 510. The notification may occur in other ways as well, such as playing a sound through the speakers of the client device. The user of client device may thus be informed with a flashing screen and beeping speaker when it moves to a location

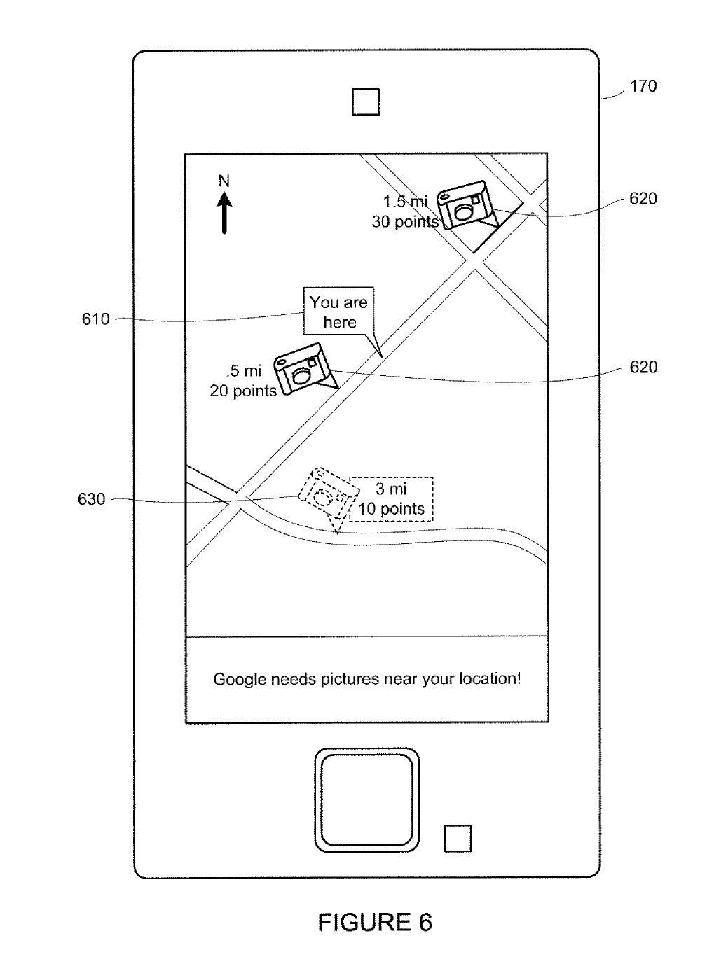

As shown in FIG. 6, client device 170 may display a map indicating the current location of the client device 610 and one or more locations which require additional images. For example, visual indicators 620 may be displayed proximate to or represent locations on a map which the server has determined require additional images. Some locations which require images may not be displayed, for example as shown in FIG. 6, camera indicator 630 may not be displayed because the server 110 may have determined that the distance from the location associated with the indicator to the device's current location is too great.

Each indicated location may be associated with various information. For example, each location may include a distance from the current location of the device and, as will be explained in more detail below, a point value associated with images of the location.

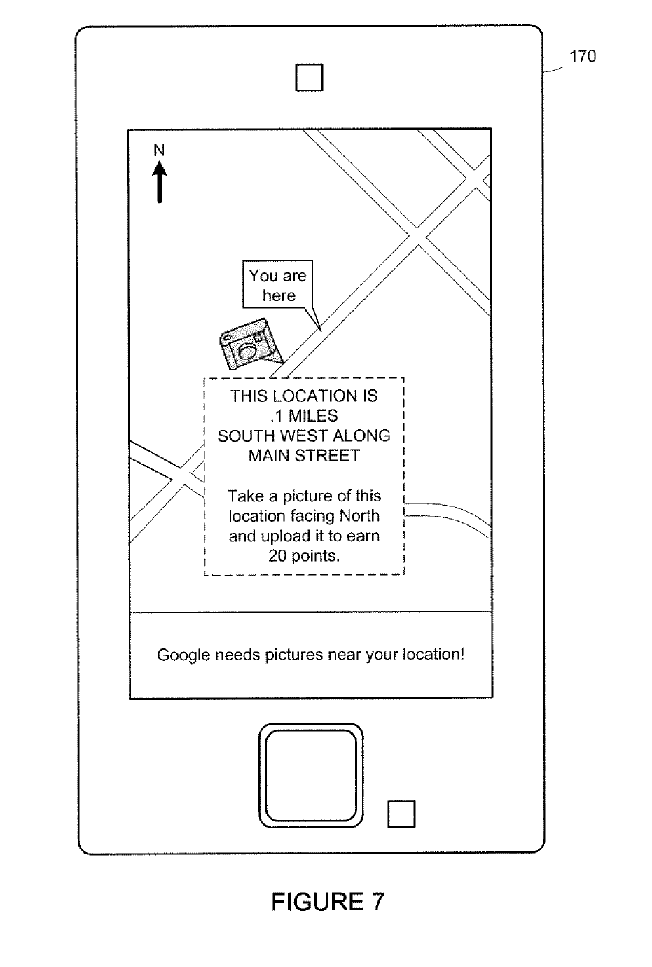

The user may select a desired location to obtain more information. As shown in FIG. 7, the program may display information regarding the location and orientation of the particular image required by the server.

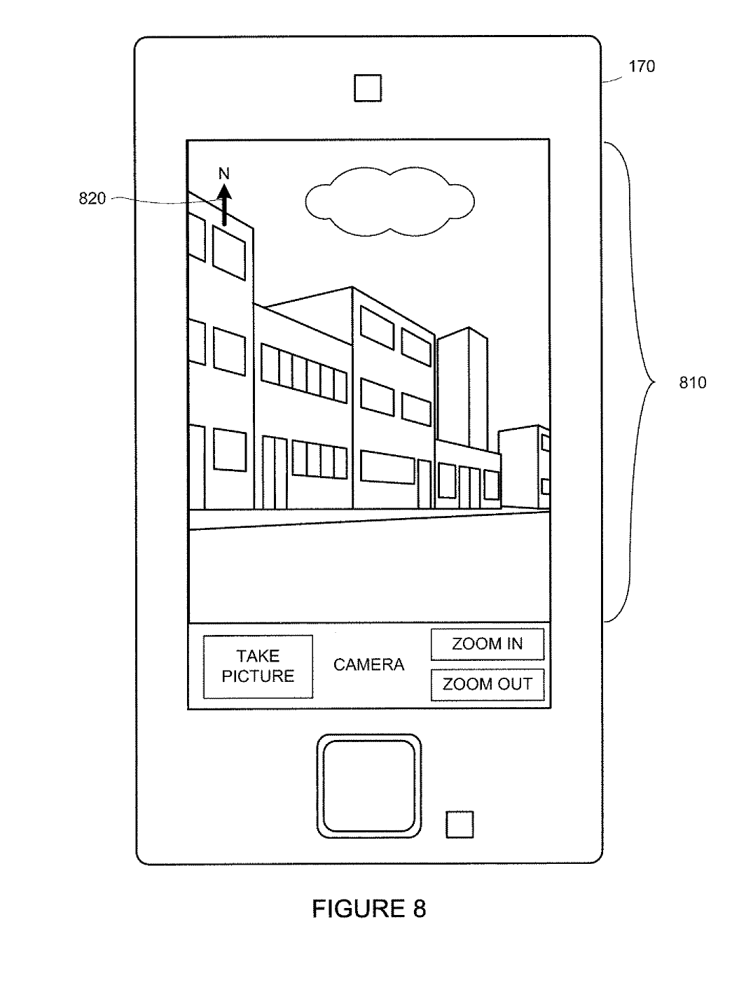

The user may then travel to the desired location, determine the proper orientation, and take a picture. In one aspect and as shown in FIG. 8, a custom program may launch allowing the user to take and preview an image 810. The program may provide the user with assistance in determining the correct orientation, such as an indication of the current orientation of the client device 820. Once the user has taken an image, the user may upload the image to server 110 with the aid of the program.

Upon receipt of the image, the server 110 may decide if the image matches other information about the location that is already accessible by the server. The verification process may involve manual moderation or computer processing to match the image against any known images. For example, server 110 may compare the uploaded image to prior images of the location, images nearby the location, or images which have already been verified. If the submitted image is too different from other images of the location, it may be rejected.

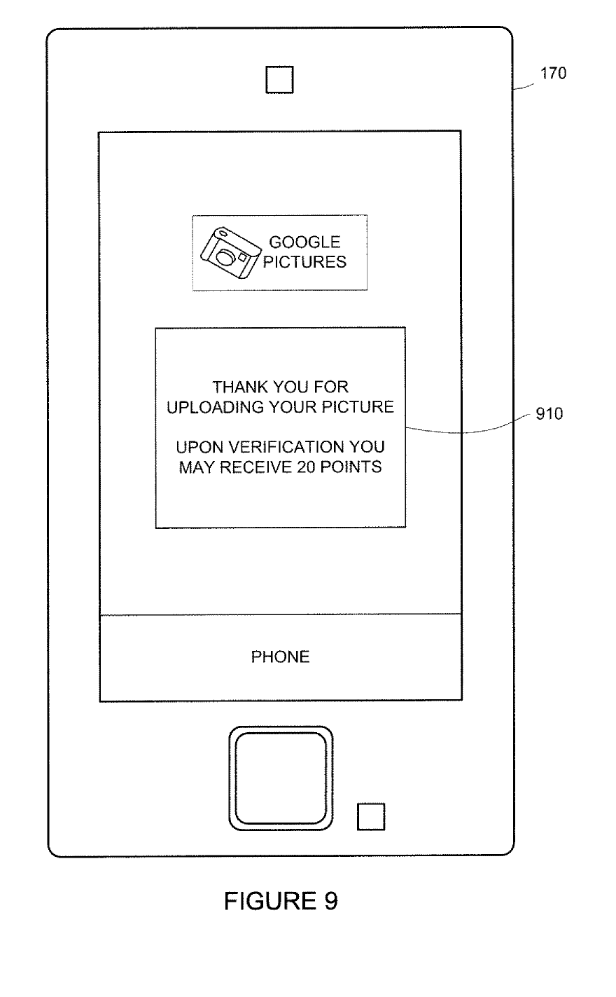

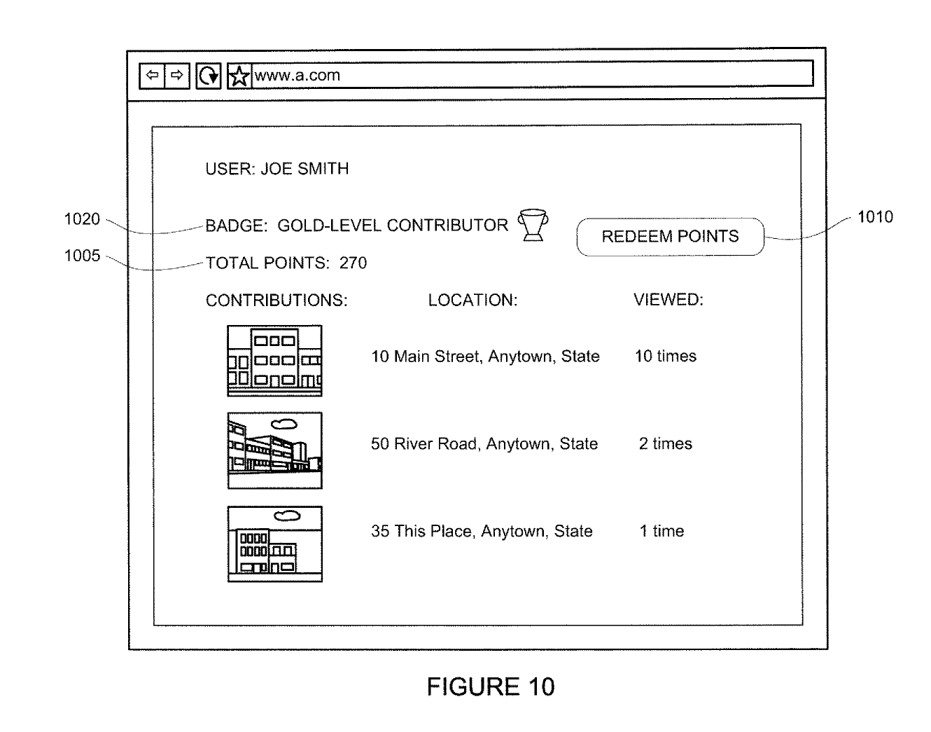

The system and method may also provide the user with incentives to provide images of particular locations. For example, as shown in FIG. 9, the device 170 may display a confirmation screen 910 thanking the user for the image and indicating points earned or to be earned. As shown in FIG. 10, the system and method may use various other incentives such as recognizing the user by giving them a title that represents the extent of their contributions. The system may also public identify the user that provided the image as the photographer when other users view the image. The system may further reward the user by tracking and allowing the user to see how many times the uploaded image has been viewed by others.

Once an image is uploaded, server 110 may associate the image with the location that was captured. When a user requests information regarding a location, the server may provide for display on a client device the image of the location that was uploaded by the submitter.

The system may also assign values images uploaded to the system that are redeemable for some other award. For example, each location may be associated with a point, token, monetary, or an arbitrary value. As shown in FIG. 6, each location may be associated with a point value, which may be indicative of the importance of additional images. For example, where there is no image data, the point value may be greater than where image quality is poor. The point value where image quality is poor may be greater than where the image is out of date. In this regard, the user may be incentivized to take and upload pictures to accumulate point values. The system and method may require that the image be verified prior to awarding points to a user. As shown in FIG. 10, a user may accumulate points 1005 which may be redeemed, for example by selecting a redeem button 1010, for items, additional recognition or money.

Users may also earn icons, symbolic titles or badges indicating a level of contribution. For example, a user who contributes often may earn the gold-level contributor badge 1020, whereas users which contribute less may be a silver or bronze level contributor. Badges may also be earned for a specific number or certain types of uploads, for example, for uploading an image of an especially significant place or images of locations in “uncharted territory.”

These incentives may be useful to establish competition among users. For example, a user may compete with other users for the greatest contribution of images, badges, or number of points. The “winner” may be awarded a monetary value or monetary bounties may be offered for images in some or all areas. In another example, users could get a special value for uploading an image to perfectly match a historical photograph. This would allow users to make side by side, “then and now” comparisons.

The system and method may also provide users with the number of times an image has been viewed. For example, as shown in FIG. 10, after a period of time, days or weeks, a user may retrieve a profile page indicating the number of times the user's uploaded images have been viewed and various other information.

The combination of two or more of the above mentioned incentives may also be encouraging to users and result in additional uploads.

One of the advantages of the invention is its ability to accommodate a wide variety of alternatives and additions to the foregoing features.

The program may allow a user to determine certain notification preferences. The user may register for notification within a specific geographic area. For example, the user may only be interested in notifications within a distance from the user's home. The user may specify a maximum distance or minimum point value. For example, the user may be willing to travel only 2 miles or 2 city blocks and only for images which have a point value of 20 or higher. The user may also register only for notifications of a specific type, for example, of a competition or of a location where there are no images.

In some instances, the system and method may identify a location where additional images are needed based on the time of day. Where the number of requests regarding a location is greater during a particular time of day, server 110 may determine that additional images of the location at a different time of day may be required. For example, a greater number of users may request information regarding the “Las Vegas Strip” during the evening hours. Server 110 may determine that additional images of the Las Vegas Strip in the evening may be required and send notifications accordingly.

Rather than notify users automatically via a dedicated notification/upload program, server 110 may wait for a request from the client device. For example, a user may receive a notification in response to a search request. The client device may use a browser such as Google Chrome or the browser installed on a Google Android cell phone to send a request for information to server 110. During the connection protocols, the browser may automatically transmit information regarding the current location of the client device to the server 110. Server 110 may use this information to determine a location of the client device and to determine if there are locations near the client device which require additional images. If server 110 determines that a location near the client device requires additional images, the server may send a notification to client device 170, such as via a web page that is displayed on the client device's browser.

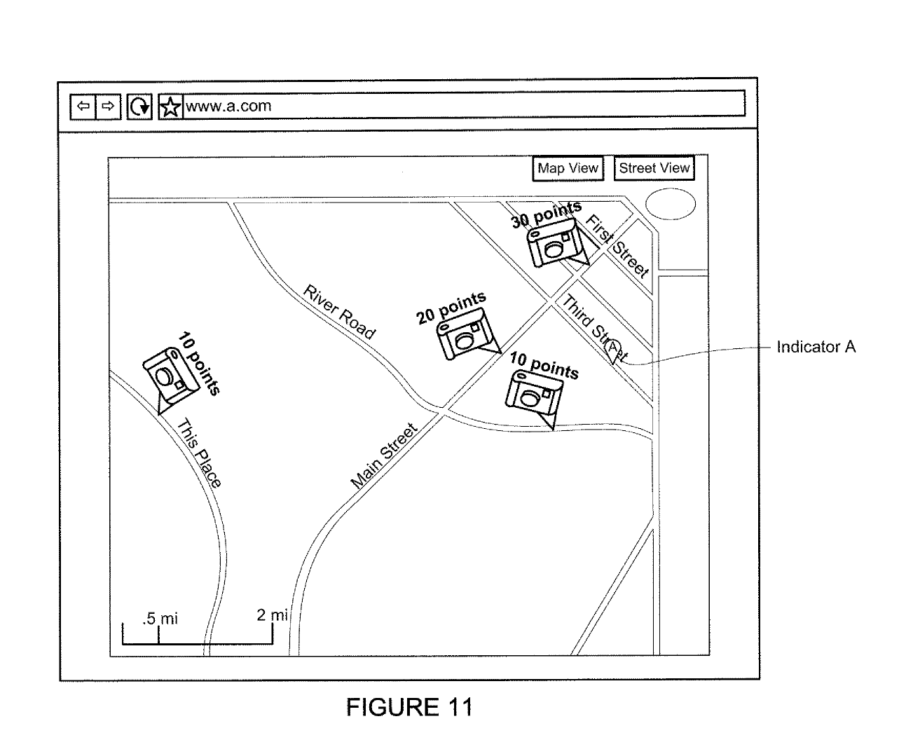

The system and method may allow users to determine a route for visiting locations to take and upload images. As shown in FIG. 11, server 110 may provide the user device with a map indicating locations which require additional images. This may allow the user to determine optimal locations, i.e. those with the most points, and plan an outing. For example, a user may request locations which require additional images proximate to a particular location or may receive the locations as a result of a notification. In this regard, indicator pin A of FIG. 11 may be associated with a location requested by a user or with the user device itself. For example, as shown in FIG. 12, a user may choose a route 1210 based on the locations where the user intends to take pictures.

The user may also take an image on a device that is different than the device that notified the user of the desired location, such as a camera.

The user may further upload the image at a later time. For example, a user may take an image with a digital camera and upload an image at a later time by connecting the camera or phone with a laptop or desktop computer. Yet further, if the image was captured with a device that is capable of wirelessly connecting to the Internet, the user may upload the photo by using the client device's built-in browser and logging into a site associated with server 110.

The system and method may provide for collecting different types of data and images. For example, users may upload audio and video of locations in addition to images. Notifications may request the collection of non-photographic information, for example, checking whether a nearby business is open, inputting business hours, or uploading an image of business hours listed on the storefront.

Notifications may also request images of current events. Server 110 may determine current events from connecting to one or more information servers 180 to review news feeds or as a result of user queries regarding the event. Current event notifications may have expiration dates, for example, to ensure that the images are collected promptly or as the event is happening.

Notifications may request specific types of images. For example, a user may receive a notification requesting a close up image of a store front or anywhere text maybe found. In another example, a user may receive a notification requesting images or video from various angles to avoid obstructions such as cars, trees, or the line.

The system and method may also involve prompting a user to register the image. For example, the user may be asked to register the image against nearby images, known landmarks, or 3D data. In another example, the user may be asked to identify any recognizable faces so that the faces may be blurred for privacy reasons.

In other aspects, functions described above as being performed by the server may be performed by the client device, and vice versa. For example, the client device may store and retrieve the map tiles for display on the device. In yet more aspects, the client device and server perform and share different functions.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only one of many possible embodiments.

1. A method comprising:
determining, by a processor, that an image of a first geographic location is needed by analyzing images of an image source, the images of the image source being associated with data identifying geographic locations, and wherein the analyzing is based on at least one of (a) a volume of user requests regarding the first geographic location, (b) whether a structure at the first geographic location has changed, and (c) whether a status of a business at the first geographic location has changed;
receiving a location of a client device;
determining, by the processor, whether the location of the client device is proximate to the first geographic location;
identifying map data for the first geographic location;
identifying a set of locations, including the first geographic location, wherein each location of the set is associated with information identifying at least one required image, and each location of the set is associated with an incentive value;
generating a notification including the map data, the set of locations, the information identifying the at least one required image, and the incentive value associated with each location of the set of locations; and
providing the notification to the client device with instructions for displaying the map data, the set of locations, and the incentive values to a user of the client device, when the client device's location is determined to be proximate to the first geographic location.

2. The method of claim 1 wherein the location of the client device is proximate to the first geographic location if the first geographic location is within a fixed distance from the client device.

3. The method of claim 1 wherein the determination of whether the location of the client device is proximate to the first geographic location is performed by the processor at a server computer.

4. (canceled)

5. The method of claim 1 wherein data of the first geographic location is latitude/longitude data.

6. The method of claim 1 wherein the first geographic location is further determined by a processor by determining whether the images of the image source are associated with data identifying the first geographic location.

7-12. (canceled)

13. A non-transitory, computer-usable medium including a program executable by a processor comprising:
computer code that maintains images of a plurality of locations;
computer code that determines which of the plurality of locations require images based on at least one of (a) a volume of user requests regarding any of the plurality of locations, (b) whether a structure at any of the plurality of locations has changed, and (c) whether a status of a business at any of the plurality of locations has changed;
computer code that receives location information from a user device;
computer code that determines a geographic location of the user device;
computer code that determines if the geographic location of the user device is proximate to a given location which has been determined to require an image;
computer code that identifies map data for the given location which has been determined to require an image;
computer code that identifies a set of locations which have been determined to require an image, including the given location which has been determined to require an image, wherein each location of the set of locations which have been determined to require an image includes information identifying at least one required image and each location of the set of locations which have been determined to require an image is associated with an incentive value;
computer code that generates a notification including the map data, the set of locations which have been determined to require an image, and the incentive values associated with each location of the set of locations which have been determined to require an image; and
computer code that transmits the notification requesting an image to the user device with instructions for displaying the map data, the set of locations associated with each location of the set of locations which have been determined to require an image, and the incentive values associated with each location of the set of locations which have been determined to require an image to a user of the client device when it has been determined that the geographic location of the user device is proximate to the location which requires an image.

14. The program of claim 13 further comprising;
computer code that receives an image of a location from a user device;
computer code that verifies whether the image of a location is one of the plurality of locations which has been determined to require an image.

15. (canceled)

16. The program of claim 13 further comprising:
computer code which receives a request from the user device to plan a route between two or more locations of the set of locations which have been determined to require an image; and
computer code which transmits, for display on the user device, the route.

17. The program of claim 13 wherein the determining which of the plurality of locations require images includes retrieving information form a node on a network, wherein the retrieved information indicates a change to a location.

18. The program of claim 13 wherein the determining which of the plurality of locations require images includes examining the number of user requests for information regarding a location.

19. The program of claim 13 wherein the notification requests an image of an event.

20. The program of claim 19 wherein the notification further includes a time limit for capturing an image.

21. A system comprising:
a first computer at a first node of a network, the first computer having access to instructions operable by the first computer, a set of locations, a set of images each image associated with one of the set of locations; and
a client device at a second node of the network different from the first node, the client device comprising a user input device, an electronic display, a processor and instructions operable by the processor;
the instructions of the first computer comprising:
receiving location data from a client device;
identifying a subset of locations of the set of locations that require additional images based on at least one of (a) a volume of user requests regarding any location of the set of locations, (b) whether a structure at any location of the set of locations has changed, and (c) whether a status of a business at any location of the set of locations has changed, and each location of the subset of locations that requires additional images being associated with an incentive value;
determining if the location data from the client device indicates a location which is proximate to a given location of the subset of locations that requires additional images;
identifying map data for the given location of the subset of locations that requires additional images;
generating, when the location data from the client device indicates the location which is proximate to the given location of the subset of locations that require additional images, a notification including the given location of the subset of locations that require additional images, the subset of locations that requires additional images, the map data, and the incentive values associated with each location of the subset of locations that requires additional images;
transmitting the notification to the client device over the network; and
the instructions of the client device comprising:
transmitting the location data from the client device to the first computer;
displaying, on the electronic display, the notification, including the subset of locations that requires additional images, the map data, and the incentive values associated with each location of the subset of locations that requires additional images transmitted by the first computer.

22. The system of claim 21 wherein the first computer is a web server.

23. The system of claim 21 wherein the client device is a mobile phone.

24. The system of claim 21 wherein the client device is a personal computer.

25. The system of claim 21 wherein the instructions of the client device further comprise transmitting a preference for notifications, and wherein the instructions of the client device further comprising transmitting the notification only if the preference is satisfied.

26. The system of claim 25 wherein the preference is for a minimum incentive value.

27. The system of claim 25 wherein the preference is for the notification to be sent only if the client device is within a particular geographic area.

28. The system of claim 25 wherein the preference is for the notification to be sent only if the user device is within a specified distance from the location of the subset of locations that requires additional images.

29. The system of claim 25 wherein the instruction of the first computer further comprise transmitting, in response to receiving an image, a request to register the image.

30. The system of claim 29 wherein registration involves identifying a location and orientation of the image.

31. The system of claim 25 wherein the instructions of the first computer further comprise transmitting, in response to receiving an image, a request to identify faces of an uploaded image.
